(19) United States
(12) Patent Application Publication
(10) Pub. No.: US 2007/0168499 A1
(43) Pub. Date: Jul. 19, 2007

(54) Configurable Modular Networking System and Method Thereof

(75) Inventor: Jing-Long Chu, Milpitas, CA (US)

Correspondence Address: WPAT, PC;INTELLECTUAL PROPERTY ATTORNEYS, 2030 MAIN STREET, SUITE 1300, IRVINE, CA, 92614, US

(73) Assignee: ACENET TECHNOLOGY INC., Santa Clara, CA (US)

(21) Appl. No.: 11/456,185

(22) Filed: Jul. 7, 2006

Related U.S. Application Data
(60) Provisional application No. 60/696,793, filed on Jul. 7, 2005.

(51) Int. Cl. G06F 15/173

(52) U.S. Cl. 709/224

(57) ABSTRACT

In one embodiment according to the principle of this present invention, a communication IC embeds a plurality of network function modules; at least one hardware module interface provides a plurality of interfaces where a plurality of hardware modules can be coupled, said hardware modules comprise secret keys corresponding to their functionalities: a second memory device stores a plurality of software modules and at least one software key, said software key corresponds to at least one function of said software modules: a general network module couples to said bus and comprises general module key corresponding to their functionalities in the system: and/or a first memory device stores at least one hardware key, said hardware key corresponds to at least one of said network function modules. By varying the combination of said hardware modules, network function modules, general module key, and software modules that are configured and enabled or disabled by said secret keys, hardware key, general module and software key, the network may expand or contract according to the need of a networking environment on a single platform.

### FIELD OF THE INVENTION

The present invention generally relates to a networking system, more particularly relates to a configurable modular networking system that provides flexible expandability on a single platform.

### BACKGROUND OF THE INVENTION

The continual improvement of technology within the networking industry is well known in the art. The industry is constantly trying to expand on current networking technology as well as develop alternative technology with corresponding advantages over more traditional networking technology. In response, protocols and standards are created and updated in order to ensure that both a compatibility and performance levels are maintained within the industry. Within this environment, it is difficult to maintain an up-to-date, diverse networking enterprise.

The infrastructure in a large enterprise containing both computer systems and networks of different types is very complex. This complexity increases as the number of different networking types, standards, and protocols integrated within an enterprise increases. Complicated function such as protocol conversion, security maintenance, and inter/intra-networking management must occur at a large number of networking interfaces within the enterprise. As a result, the design and actual implementation of an enterprise requires both a large expenditure of time and money. However, as networking technology changes, this design may quickly become obsolete. Due to the complexity of enterprise infrastructures, upgrading an obsolete infrastructure is generally very costly as well. In fact, oftentimes, networking devices (e.g., gateways, bridges, and routers) are discarded and replaced with versions containing newer technology. In addition, MIS people have to relearn the network operation each time when the infrastructure is updated. As a result, the cost of maintaining a stable enterprise is usually very high; frequently higher than the initial design and implementation costs. Nowhere is this problem more relevant than in the office networking arena.

The OSI, or Open System Interconnection, model defines a networking framework for implementing protocols in seven layers. Control is passed from one layer to the next, starting at this application layer in one station, proceeding to the bottom layer, over the channel to the next station and back up the hierarchy.

Physical Layer (Layer 1): This layer conveys the bit stream—electrical impulse, light or radio signal—through the network at the electrical and mechanical level. It provides the hardware means of sending the receiving data on a carrier, including defining cables, cards and physical aspects. Fast Ethernet, RS232, and ATM are protocols with physical layer components.

Data Link Layer (Layer 2): At this layer, data packets are encoded and decoded into bits. It furnishes transmission protocol knowledge and management and handles errors in the physical layer, flow control and frame synchronization. The data link layer is divided into two sublayers: The Media Access Control (MAC) layer and the Logical Link Control (LLC) layer. The MAC sublayer controls how a computer on the network gains access to the data and permission to transmit it. The LLC layer controls frame synchronization, flow control and error checking.

Network Layer (Layer 3): This layer provides switching and routing technologies, creating logical paths, known as virtual circuits, for transmitting data from node to node. Routing and forwarding are functions of this layer, as well as addressing, internetworking, error handling, congestion control and packet sequencing.

Transport Layer (Layer 4): This layer provides transparent transfer of data between end systems, or hosts, and is responsible for end-to-end error recovery and flow control. It ensures complete data transfer.

Session Layer (Layer 5): This layer established, manages and terminates connections between applications. The session layer sets up, coordinates, and terminates conversations, exchanges, and dialogues between the applications at each end. It deals with session and connection coordination.

Presentation Layer (Layer 6): This layer provides independence from differences in data representation (e.g., encryption) by translating from application to network format, and vice versa. The presentation layer works to transform data into the form that the application layer can accept. This layer formats and encrypts data to be sent across a network, providing freedom from compatibility problems. It is sometimes called the syntax layer.

Application Layer (Layer 7): This layer supports application and end-user processes. Communication partners are identified, quality of service is identified, user authentication and privacy are considered, and any constraints on data syntax are identified. Everything at this layer is application-specific. This layer provides application services for file transfers, e-mail, and other network software services. Telnet and FTP are applications that exist entirely in the application level. Tiered application architectures are part of this layer.

Office often requires additional or stricter network function, among the Layers of the OSI model, above those offered in more traditional networks. For example, certain businesses may require a high level of security within their network to protect valuable data. Additionally, businesses may require certain network management function in order to properly operate within an office environment. These various functionality levels within different interfacing networks further increase the complexity of an enterprise infrastructure containing these networks.

Networking technologies in this market place have been changing at a rapid place in order to satisfy the bandwidth and the network functionalities within the office networking arena. Specifically, networks and corresponding enterprises must be upgraded in order to incorporate these technology advances. This upgrade is typically very expensive due to the price of the new networking devices, the cost of training the MIS people, as well as the cost in integrating these devices within existing infrastructures.

### SUMMARY OF THE INVENTION

According to one aspect of the present invention, it is one objective of the present invention to provide an expandable, configurable networking device capable of providing flexible network functionalities on a single platform through configuration by the module keys instead of intrinsic software on the platform. By this way, a configurable modular platform will not perform any function until is told by the keys to do so such that said platform can be kept as a unified platform with versatile modules.

According to another aspect of the present invention, one of the objectives is to provide configurable modular network system that is not discarded as the infrastructure expands. Instead, modules or keys will be upgraded to update the whole system.

According to another aspect of the present invention, it is another objective of the present invention to include appropriate network function within the bus and allow these network functions to grow or contract as a network's needs change.

A configurable modular networking system, comprising:

A CPU coupling to a bus, said CPU is adapted to manage said networking system.

A communication IC coupling to said bus, said bus is adapted to provide a path between said CPU and said communication IC, and said communication IC is adapted to provide a plurality of network function modules.

A first memory device coupling to said communication IC and/or said CPU, said first memory device is adapted to store at least one hardware key. Each of said hardware keys corresponds to at least one of the network function modules of said communication IC.

A second memory device coupling to said CPU, said second memory device is adapted to store software modules. Each of said software module comprises at least one software function. Said second memory device is further adapted to store at least one software key. Each of said software keys corresponds to at least one of said software modules.

And at least one hardware module interface coupling to said communication IC; said hardware module interface is adapted to provide a plurality of functions can be added. Each of said hardware modules comprises at least one secret key.

The configurable modular networking system of further comprises: at least one general network module can be coupled to said bus of claim 3, each general network module comprising at least one general module key, wherein said general network modules can be configured by said general module keys.

Wherein:

The network function modules are configured and enabled by the hardware keys. The software modules are enabled by the software keys. The hardware modules are enabled by the secret keys. The general network modules are enabled by the general module keys. Thus, the software modules, network function modules, hardware modules and general network modules are configurable by varies combinations of said software keys, hardware keys, secret keys and general module keys.

### BRIEF DESCRIPTION OF THE DRAWINGS

FIG. 1 is a block diagram of an embodiment of the present invention;

FIG. 2 is a more detailed block diagram of said embodiment of the present invention;

FIG. 3 is a block diagram of a preferred embodiment according to the principles of the present invention;

FIG. 4 is another block diagram of a preferred embodiment according to the principles of the present invention;

FIG. 5 is a flowchart of the procedure for upgrading the function of the embodiment of this present invention;

FIG. 6 is a flowchart of the procedure for upgrading hardware modules;

FIG. 7 is a flowchart of the procedure for upgrading function modules of said communication IC; and

FIG. 8 is a flowchart of the procedure for upgrading function of the software modules.

### DETAILED DESCRIPTION OF THE PREFERRED EMBODIMENTS

A configurable modular networking system and corresponding methods are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

Unless specifically stated otherwise as apparent from the following discussion, it is appreciated that throughout the description, discussions such as “processing” or “computing” or “determining” or “switching” or “converting” or the like, refer to the action and process of a computing system or networking system that manipulates and transforms data represented as physical (electronic) quantities within the system's registers and memories into other data similarly represented as physical quantities within the system registers or memories or other such information storage, transmission or display devices.

It should be noted that the language used in this disclosure has been principally selected for readability and instructional purposes, and may not have been selected to delineate or circumscribe the inventive subject matter, resort to the claims being necessary to determine such inventive subject matter.

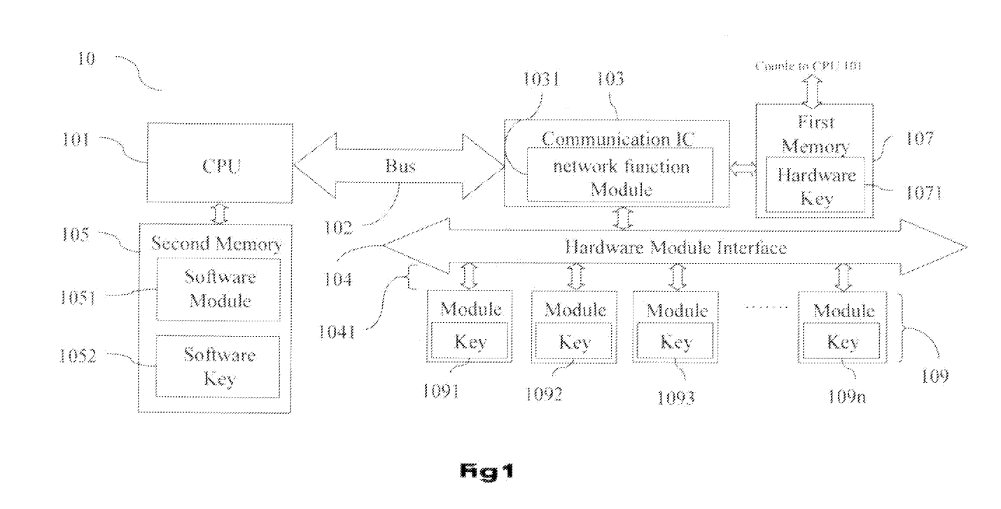

FIG. 1 is a block diagram of an embodiment of the present invention. In this embodiment of a configurable modular networking system 10 comprises:

A CPU 101 coupling to a bus 102, said CPU 101 is adapted to manage said networking system 10.

A communication IC 103 coupling to said bus 102, said bus 102 is adapted to provide a path between said CPU 101 and said communication IC 103. Such communication IC 103 is adapted for embedding a plurality of network function modules 1031.

A hardware module interface 104 coupling to said communication IC 103, said hardware module interface 104 is adapted to provide a plurality of interfaces 1041 where a plurality of hardware modules 109 can be coupled which provide expandability to said system. Each of said hardware modules 109 comprises a secret keys 1091, 1092, 1093, 109n corresponding to their functionalities.

A first memory 107 coupling to said communication IC 103 and/or CPU 101, said first memory 107 is adapted to store a hardware key 1071. Said hardware key 1071 corresponds to at least one of said network function Modules 1031 embedded in the Communication IC 103.

And a second memory 105 coupling to said CPU 101, said second memory 105 is adapted to store a plurality of software modules 1051 corresponding to said network function modules 1031 embedded in said communication IC 103 and also corresponding to said hardware modules 109. Each of said software modules 1051 comprises at least one software function corresponding to said network function modules 1031 or said hardware modules 109. Said second memory device 105 is further adapted to store a software key 1052. Said software key 1052 corresponds to at least one function of said software modules 1051.

Wherein:

By coupling said hardware modules 109 to said hardware module interface 104, and the corresponding secret keys 1091, 1092, 1093, 109n are verified by said CPU 101 and/or said communication IC 103 as valid secret keys, said hardware modules 109 are enabled.

By replacing the hardware key with a new hardware key 1071 in said first memory device 107, and such new hardware key is verified by said CPU 101 and/or said communication IC 103 as a valid hardware key 1071, the corresponding network function modules 1031 embedded in said communication IC 103 are enabled.

And by replacing the software keys with a new software key 1052 in said second memory device 105, and such new software key is verified by said CPU 101 and/or said communication IC 103 as a valid software key, the corresponding software modules 1501 are enabled.

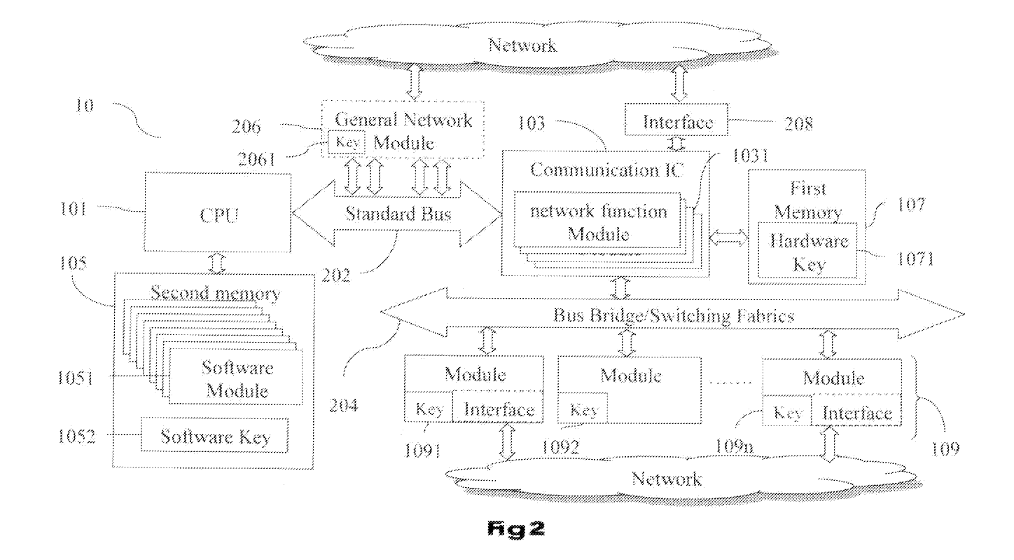

FIG. 2 is a more detailed block diagram of the embodiment of the present invention. As shown in FIG. 2, besides being a path between said CPU 101 and said communication IC 103, the bus 102 may also be implemented as an standard bus 202 according to industrial standards, such as PCI bus, mini-PCI bus, PCI-X bus, PCI Express bus, SPI-3 bus and so on. As a result, general network modules 206, i.e. interface cards, may be coupled to the standard bus 202 to expand the functionality of said system 10, such as VPN card, content filtering card, IPS card, etc. Said general network modules 206 may have their own access interfaces coupling to different types of networks, network modules also may have said general module keys 2061 to indicated the functionalities associated with said system 10.

An interface 208 within a plurality of access interfaces may be coupled to said communication IC 103. Said interface 208 may be coupled to a network for transmitting and receiving packets from said network.

The hardware module interface 104, as shown in FIG. 1, may be implemented as a bus bridge/switching fabrics 204 with “bus bridge chips” (e.g. PCI Bridge, PCI-X Bridge, SP13 Bridge, or even custom designed chipsets) or “switch chip”. Said bus bridge/switching fabrics 204 collaborating with said communication IC 103 provide higher performance than said industrial standard bus 202.

Said communication IC 103 may be a proprietary networking ASIC chipset. A plurality of firmware information and/or driver corresponding to said hardware modules 109 may be embedded in said communication IC 103. As a result, while coupling hardware modules 109 to said hardware module interface 204, the hardware modules are automatically operable with simpler configuration efforts. Some of said hardware modules 109 may also have their own access interfaces for coupling to different types of networks, such as fast Ethernet, Cable modem, xDSL, optical fiber network and wireless LAN.

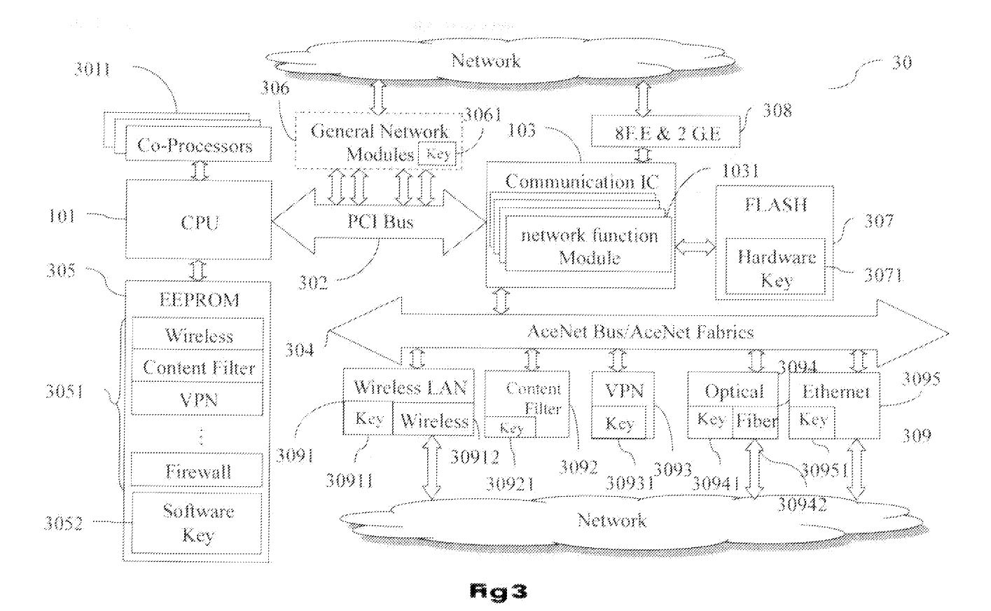

FIG. 3 is a block diagram of a preferred embodiment according to the principles of the present invention, comprising:

A CPU 101 coupling to a PCI bus 302, said CPU 101 is adapted to manage said networking system 30. A plurality of co-processors 3011 coupling to said CPU 101. Said co-processors 3011 are adapted to collaborate with said CPU 101 to manage said networking system 30. A communication IC 103 coupling to said PCI bus 302, said PCI bus 302 is adapted to provide a path between said CPU 101. Said PCI bus 302 further provides a plurality of slots where general network modules 306, i.e. PCI interface cards, may be coupled for expanding the functionality of said system 30. Said general network modules 306 may have their own access interfaces coupling to different types of networks, such as fast Ethernet, Cable modem, xDSL and wireless LAN. Said communication IC 103 may be a proprietary networking ASIC chipset, which is adapted to provide a plurality of network function modules, comprising:
A. Network security function modules, including: wire-speed Stateful Firewall, DoS/DDoS prevention, IDS/IPS, Content Security, Policy-based AAA (Authorization, Authentication, Accounting), WLAN Security, etc.
B. Broadband gateway function modules, including: NAT/NAPT, policy-based subscriber accounting, authorization and authentication, bandwidth management, multi-ISP supporting and switching, flow control, flow monitoring, QoS customization, customization of charging policy based on service, etc. And
Switching/routing function modules, including: wire-speed layer two to layer five of the OSI module switching/policy routing, rate control, multi-policy of QoS, flow classification, flow control/management, session rate control/management, multicast routing, policy routing and redirection, remote monitoring, etc.

A FLASH memory 307 coupling to said communication IC 103 and/or CPU101, said FLASH memory 370 is adapted to store a hardware key 3071. Said hardware key 3071 corresponds to at least one of said network function modules 1031 embedded in said communication IC 103 described above.

An interface 308 within a plurality of access interfaces, e.g. m Fast Ethernet ports and n Gigabit Ethernet ports (m,n=integer), coupling to said communication IC 103, said interface 308 is adapted to couple to a network for transmitting and receiving packets from said network.

A hardware module interface implemented with a custom designed chipset, say, AceNet Bus/AceNet Fabrics 304, coupling to said communication IC 103, said AceNet Bus/AceNet Fabrics 304 is adapted to provide a plurality of interfaces where a plurality of hardware modules 3091, 3092, 3093, 3094, may be connected so that additional function can be added. Said AceNet Bus/AceNet Fabrics 304 collaborating with said communication IC 103 may provide higher performance than said PCI bus 302. Said communication IC 103 is further adapted to embed a plurality of firmware and drivers for hardware modules 3091, 3092, 3093, 3094, such that hardware modules (e.g. Wireless LAN module 3091, Content Filter module 3092. VPN module 3093, Optical module 3094. Ethernet module 3095) coupling to said AceNet Bus/AceNet Fabrics 304 may automatically operable without manual configuration efforts (e.g., Plug-and-Play).

An EEPROM (and/or flash memory) 305 coupling to said CPU 101, said EEPROM 305 is adapted to store a plurality of software modules 3051. Said software modules 3051 corresponds to said network function modules 1031 of said communication IC 103 and said hardware modules 109 (e.g. Wireless LAN module 3091, Content Filter module 3092, VPN module 3093, Optical module 3094, Ethernet module 3095). Said EEPROM (or flash memory) 305 is further adapted to store a software key 3052. Said software key 3052 corresponds to at least one of said software modules 3051.

A Wireless LAN module 3091 coupling to said AceNet Bus/AceNet Fabrics 304, said Wireless LAN module 3091 is adapted to provide wireless interface 30912 to couple to a wireless network for transmitting and receiving packets from said wireless network. Said Wireless LAN module 3091 comprises a secret key 30911.

A content Filter module 3092 coupling to said AceNet Bus/AceNet Fabrics 304. Said Content Filter module 3092 is adapted to provide analysis and isolation as well as further operation of packets according to their content. Said content Filter module 3092 comprises a secret key 30921.

A virtual private network (VPN) module 3093 coupling to said AceNet Bus/AceNet Fabrics 304, said VPN module 3093 is adapted for implementing a virtual private network. Said virtual private network (VPN) module 3093 comprises a secret key 30931.

An optical filter module 3094 coupling to said AceNet Bus/AceNet Fabrics 304, said optical fiber module 3094 is adapted to provide an optical fiber access interface 30942 coupling to an optical network for transmitting and receiving packets from said network. Said optical fiber module 3094 comprises a secret key 30941.

An Ethernet module 3095 coupling to said AceNet Bus/AceNet Fabrics 304, said Ethernet module 3095 is adapted to provide an Ethernet access interface coupling to an Ethernet network for transmitting and receiving packets from said network. Said Ethernet module 3095 comprises a secret key 30951.

Wherein,

By coupling said hardware modules (e.g. Wireless LAN module 3091, Content Filter module 3092, VPN module 3093, Optical module 3094, Ethernet module 3095) to said AceNet Bus/AceNet Fabrics 304, and the corresponding secret keys 30911, 30921, 30931, 30941, 30951 are verified by said CPU 101 and/or said communication IC 103 as valid secret keys, said hardware modules 3091, 3092, 3093, 3094, 3095 are enabled.

By replacing said hardware key 3071 with an updated key, the new key will be verified by said CPU 101 and/or said communication IC 103 as a new valid hardware key. Thus, the corresponding network function modules embedded in said communication IC 103 are enabled.

By replacing said general module key 3061 with an new one, the new key will be verified by said CPU 101 and/or said communication IC 103 as a new valid general module key. Thus, the corresponding function said general network modules are enabled.

Similarly, by replacing said software key 3052 with an new one, the new key will be verified by said CPU 101 and/or said communication IC 103 as a new valid software key. Thus, the corresponding function said software modules are enabled.

Further, said software key 3052 further corresponds to hardware modules Wireless LAN module 3091, Content Fiber module 3092, VPN module 3093, Optical module 3094, Ethernet module 3095, and all of said network function modules 1031. Said hardware key 3701 further corresponds to all of said software modules 3051, network function modules 1031, and hardware modules 309, including Wireless LAN module 3091, Content Filter module 3092, VPN module 3093, Optical module 3094, Ethernet module 3095, And said secret keys 30911, 30921, 30931, 30941, 30951 further correspond to all software modules 3051 and all network function modules 1031. Wherein all software modules 3051, all network function modules 1031 and hardware modules 309, including Wireless LAN module 3091, Content Filter module 3092, VPN module 3093, Optical module 3094, Ethernet module 3095 are enabled or disabled by said CPU 101 and/or communication IC 103 according to the corresponding software key 3052, hardware key 3071, general module key 3061 and secret keys 30911, 30921, 30931, 30941, 30951 presented in said system. Said software key 3052, said hardware key 3071, general module key 3061 and said secret keys 30911, 30921, 30931, 30941, 30951 may be expired in a predetermined period of time, such that the corresponding functions are disable and require a new valid “key”. Said software key 3052, said hardware key 3071, general module key 3061 and said secret keys 30911, 30921, 30931, 30941, 30951 may further be encrypted to enhance the security of said system. In short, all of the functions inside the networking system 30, including the software modules 3051, the network function module 1031, the general network module 306 and the hardware modules 309, may be activated or deactivated by said CPU 101 and/or said communication IC 103 according to the information stored in the “keys”.

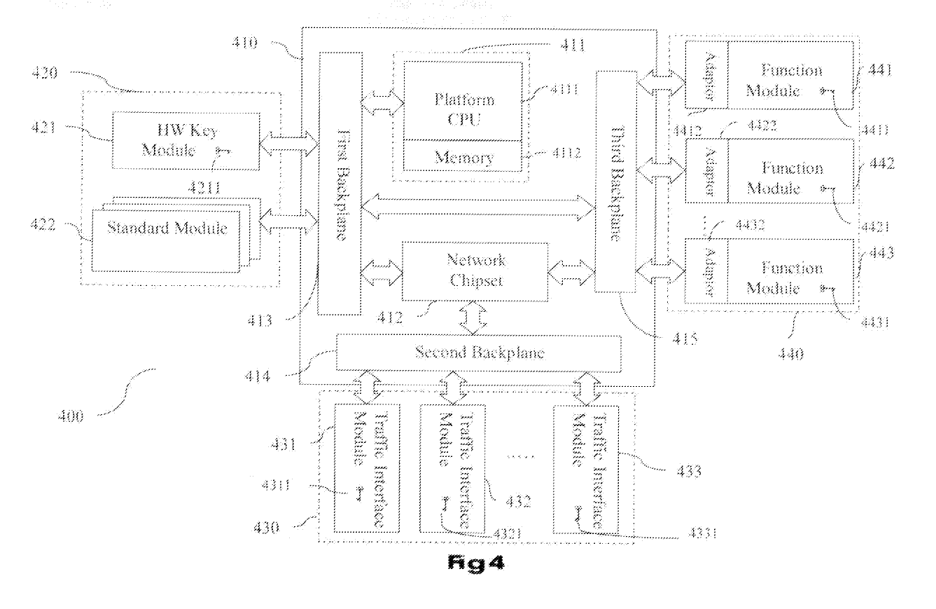

FIG. 4 is a block diagram of another preferred embodiment according to the principles of the present invention. In this embodiment, the configurable modular networking system may comprise: a networking system platform 410 with a system core 411, a network chipset 412, a first backplane 413, a second backplane 414, a third backplane 415 and at least one secret key. The system core 411 is generally consisted of a platform CPU 4111 and memory 4112, as known to the person skilled in the art. The platform CPU may be further implemented with a plurality of CPUs to increase the power of the system core 411. The first backplane 413 may work as a “bus” which delivers various data values, instructions, and information from the system core 411 to all the devices and components inside the network system 400 and vice versa, as well as the different peripherals and devices attached. The first backplane 413 may be implemented with several kinds of buses including PCI bus, PCI express, CPCI bus, SP13, etc. Because the first backplane 413 is configured to compatible with the standard interface cards, standard interface modules 422 may be coupled to provide extra functionalities to the network system 400. But one fact must be mentioned is that the speed of the standard modules 422 is usually limited by the speed of the first backplane 413. Inside the network system 400, the network chipset 412 may be coupled to the first backplane 413 as a network “accelerator”, which provides full or most Layer 2 to Layer 4 network capabilities and partial Layer 5 to Layer 7 network function including, but not limited to, WLAN Security, NAT/NAPT, VPN support, content filtering, bandwidth management, multi-ISP supporting and switching, flow control, flow monitoring, QoS customization, customization of billing policy based on service, wire-speed layer two to layer four switching/policy routing, rate control, multi-policy of QoS, flow classification, flow control/management, session rate control/management, multicast routing, policy routing and redirection and remote monitoring. The second backplane 414 may be coupled to the network chipset 412 to provide interfaces for traffic interface modules 431, 432, 433. Almost all network traffic may be delivered into or out of the network system 400 via those traffic interface modules 431, 432, 433. Each of the traffic interface modules 431, 432, 433 may be compatible with different types of traffic interfaces including but not limited to fast Ethernet ports, Gigabit Ethernet ports, fiber optical ports, and wireless ports. Users or enterprises may install different traffic interface modules 431, 432, 433 according to their need. The third backplane 415 may be coupled to the network chipset 412 to provide interfaces for function modules 441, 442, 443, such that function modules 441, 442, 443 may be coupled to provide extra functionalities to the network system 400. Because the network chipset 412 provides only partial Layer 5 to Layer 7 functions and might not completely support the Layer 2 to Layer 4 functions, these function modules 441, 442, 443 may provide the expandability and the upgradeability for the network system 400 to provide any other functionalities that is not supported in the network chipset 412. These functions of modules 441, 442, 443 may include, but not limited to, all kinds of content based functions, VPN, Anti-virus, Firewall, DoS/DDoS prevention, IDS/IPS, Content Security, Policy-based AAA (Authorization, Authentication, Accounting), WLAN Security, NAT/NAPT, policy-based subscriber authorization and authentication, bandwidth management, QoS customization, customization of billing policy based on service, multi-policy of QoS, policy routing and redirection, and remote monitoring. In one embodiment, the third backplane 415 may be implemented with a high-bandwidth switching fabric (e.g. gigabit) and each of the function modules 441, 442, 443 may further comprise, if necessary, an adaptor 4412, 4422, 4432 such that traffic or proprietary data may be transferred between the system platform 410 and the function modules 441, 442, 443. There may be several secret keys 4211, 4311, 4321, 4331, 4411, 4421, and 4431 in this network system 400. In this embodiment, a hardware key module 421 coupling to the first backplane 413 may be implemented to store a secret key 4211. Secret keys 4311, 4321, and 4331 may be integrated into the traffic interface modules 431, 432, 433. And, Secret keys 4411, 4421, and 4431 may be integrated with the function modules 441, 442, and 443. The purpose of these secret keys 4211, 4311, 4321, 4331, 4411, 4421, 4431 is to provide information for the system core 411 to decide witch function to be activated.

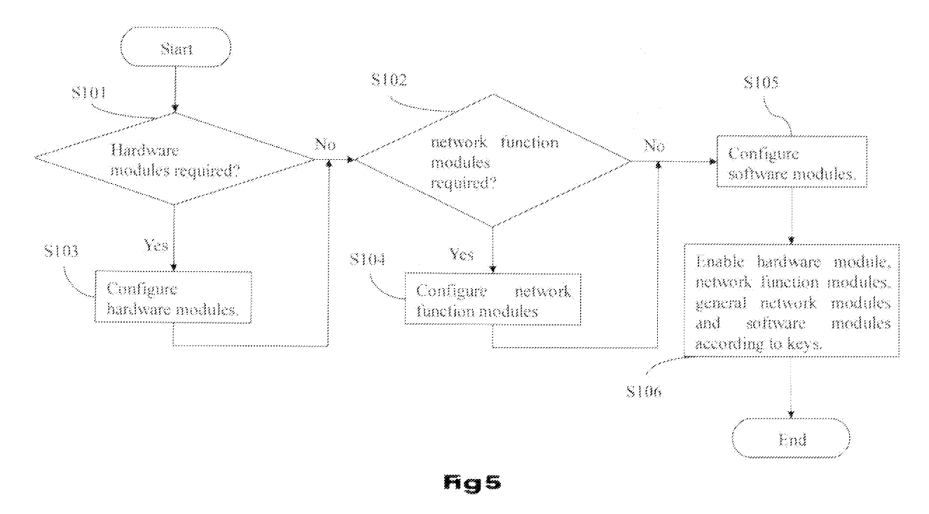

Referring to FIG. 5, a flowchart of configuring the function of one embodiment of this present invention, in this embodiment, the procedure comprises the following steps.

Check if an additional hardware module is required S101; if it does, initiate the procedure for configuring hardware modules S103, if not, go to the next step.

Check if an additional network function module is required S102, if it does, initiate the procedure for configuring network function modules of the communication IC S104, if not, go to the next step.

Initiate the procedure for configuring software modules S105.

And finally, enable hardware modules, network function modules and software modules according to the keys, i.e., secret keys, hardware keys and software keys.

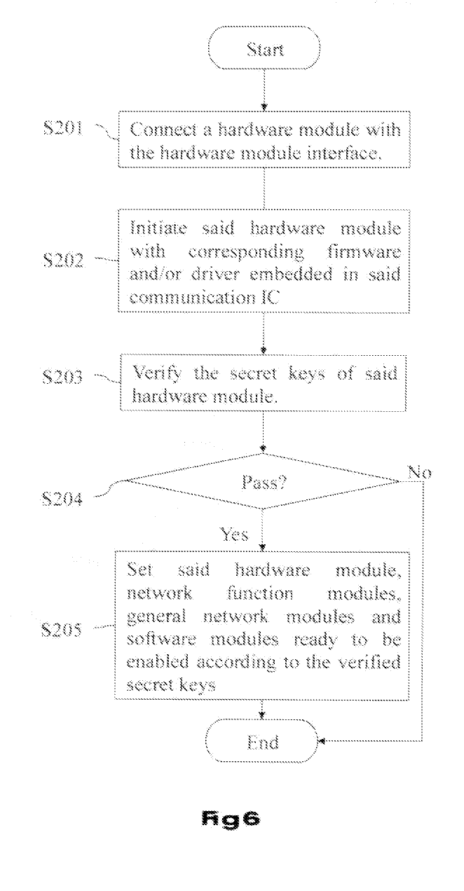

Referring to FIG. 6, a flowchart of the procedures for configuring hardware modules S103, comprising:

Couple a hardware module to said hardware module interface S201.

Initiate said hardware module S202.

Verify the secret key of said hardware module S203.

Determine if said secret key is valid S204.

Set the corresponding hardware module, network function modules, general network module and software modules of the verified secret key ready to be enabled S205.

For example, a wireless module is coupled to said hardware module interface. Said wireless module is adapted to provide wireless access interface coupled to a wireless network which transmits packets to said wireless network and receives packets from said wireless network. In this example, additional wireless access interface may be necessary for upgrading such function.

For another example, a content filter module is coupled to said hardware module interface. Said Content Filter module is adapted to provide analysis and isolation as well as further operation of packets according to their content. In this example, additional content filtering engine may be necessary for upgrading such function.

For another example, a virtual private network module is coupled to said hardware module interface. Said virtual private network module is adapted for implementing a virtual private network function. In this example, additional encryption module and Ethernet access interfaces may be necessary for upgrading such function.

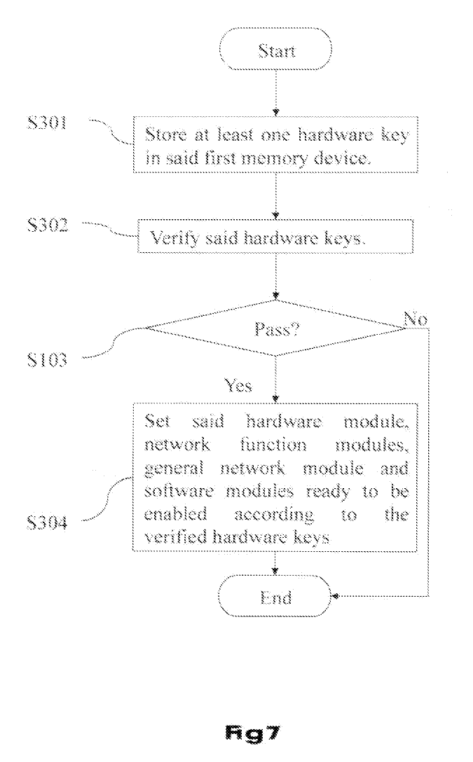

Referring to FIG. 7, a flowchart of the procedure for configuring function modules of said communication IC S104, comprising the following steps:

Store at least one hardware key in said first memory device S301.

Verify said hardware keys S203.

Determine if said hardware keys are valid S303.

Set the corresponding hardware modules, network function modules and software modules of the verified hardware keys ready to be enabled S304.

For example, function modules of said communication IC those are enabled/disenabled by said hardware key comprises:

Network security function includes, but not limited to, Firewall, Application Firewall, VPN, DoS/DDoS prevention, IDS/IPS, Content Security, Policy-based AAA (Authorization, Authentication, Accounting) Anti-Virus, Anti-Span, URI, blocking, WLAN Security, etc;

Broadband gateway function includes, but not limited to, NAT/NAPT, policy-based subscriber authorization and authentication, bandwidth management, multi-ISP supporting, flow control, flow monitoring, load balancing, QoS customization, customization of billing policy based on service, etc; and

Switching/routing function including wire-speed layer two to layer four of the OSI model switching/policy routing, rate control, multi-policy of QoS, flow classification, flow control/management, session rate control/management, multicast routing, policy routing and redirection, and remote monitoring.

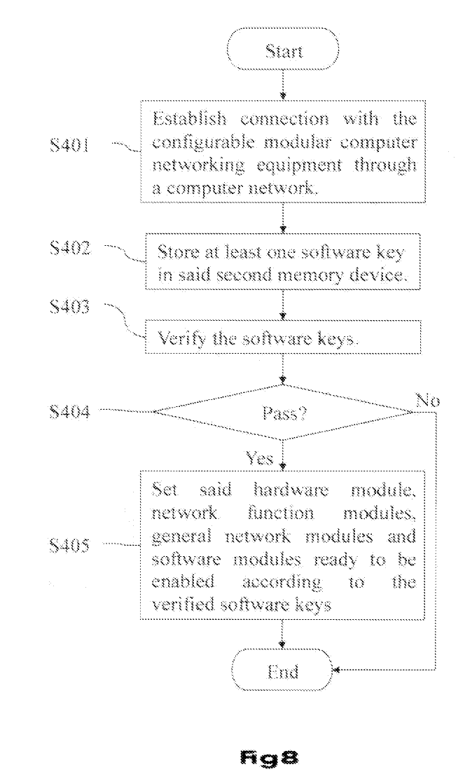

Referring to FIG. 8, a flowchart of the procedure for configuring software modules S105, comprising the following steps:

Establish connection with the configurable modular networking system through a computer network S401.

Store at least one key in said second memory device S402.

Verify said keys S403.

Determine if said keys are valid S404.

Set the corresponding hardware module, network function modules and software modules ready to be enabled by the verified keys S405.

While the present invention has been described with reference to certain preferred embodiments, those skilled in the art will recognize that various modifications may be provided. Variations upon and modifications to the preferred embodiments are provided for by the present invention, which is limited only by the following claims.

What is claimed is:

1. A configurable modular networking system is a network appliance system that not only configured by the embedded software or keys but also the keys from any of physically plugged in module. Where, said key is the short information pre-stored in the non-vaporized memory such as flash memory of system and/or physically plugged-in modules before system power up and used to determine the system functions by configuring part or whole of the network appliance system including physically plugged-in modules. Such configuration technology is called, by AceNet, as Deterministic Notification Attachment (DNA) Technology.

2. The keys, which could be encrypted, of those physically plugged-in modules and/or said system can be updated through internet.

3. A configurable modular networking system, comprising:
at least one CPU coupling to a bus, said CPU being adapted to manage said networking system;
at least one communication IC coupling to said bus, said communication IC being adapted for embedding a plurality of network function modules;
at least one hardwaremodule interface coupling to said communication IC, said hardware module interface being adapted to provide a plurality of interfaces where a plurality of hardware modules can be coupled, each of said hardware modules comprising at least one secret key; wherein said hardware modules can be configured by said secret keys; and
a first memory device which is either embedded in the system or a physically plugged in hardware key module couples, directly or indirectly, to said communication IC and/or said CPU (through said bus). Said first memory device being adapted to store at least one hardware key, each of said keys corresponds to at least one of said network function modules and/or any other software modules in the whole system and enables the corresponding network function modules and/or said software modules in the whole system.

4. The configurable modular networking system of claim 3 further comprises:
a second memory device coupling to said CPU, said second memory device being adapted to store a plurality of software modules and at least one software key, each of said software keys corresponds to at least one of said software modules and enables the corresponding software modules.

5. The configurable modular networking system of claim 4 further comprises:
at least one general network module can be coupled to said bus of claim 3, each general network module comprising at least one general module key,
wherein said general network modules can be configured by said general module keys.

6. The configurable modular networking system of claim 4 further comprises:
Said bus could be a standard CPU bus such as PCI bus, PCI-express, CPCI bus, SP13 bus, etc.

7. The combination of said secret keys of claim 3, said hardware keys of claim 3, said general module keys of claim 5 and said software keys of claim 4, may also configure the software modules of claim 4, hardware modules of claim 3, general network module of claim 5 and/or network function modules of claim 3. The priority and configuring rules of said keys above can be determined in advance.

8. The configurable modular networking system of claim 7 further comprises:
each of said software keys of claim 4 may further corresponds to at least one of said hardware modules, said software modules, said general network modules and/or said network function modules;
each of said general module keys of claim 5 may further corresponds to at least one of said hardware modules, said software modules, said general network modules and/or said network function modules;
each of said hardware keys of claim 3 may further corresponds to at least one of said hardware modules, said software modules, said general network modules and/or said network function modules; and
each of said secret keys of claim 3 may further corresponds to at least one of said hardware modules, said software modules, said general network modules and/or said network function modules;
such that
each of said software modules, network function modules, general network modules and hardware modules is enabled and configured while at least one corresponding software key, one corresponding hardware key, general module key and/or one corresponding secret key are presented and valid in the system.;

9. The configurable modular networking system of claim 5 further comprises:
Each of said software modules, network function modules, general network modules and hardware modules could be added to said system as necessary and be enabled or disabled according to at least one of th said software keys, hardware keys, general module keys and/or secret keys in said system.

10. The configurable modular networking system of claim 3, wherein said hardware module interface may be implemented with a group of interfaces, a bus bridge chip, a switch chip or a switching fabric.

11. The configurable modular networking system of claim 4, wherein the corresponding tirmware and/or driver information of said hardware modules can be embedded in said communication IC.

12. The configurable modular networking system of claim 9, wherein an interface within a plurality of access interfaces is coupled to said communication IC, said interface is adapted to couple to a network and transmit packets to said network and receive packets from said network.

13. The configurable modular networking system of claim 3, wherein said communication IC can be networking ASIC chipsets.

14. The configurable modular networking system of claim 9, wherein each of said software keys, said hardware keys, said general module keys and said secret keys may be time expiring and/or encrypted.

15. The configurable modular networking system of claim 9, wherein said hardware modules, general network modules can be selected from a group comprising:
a Wireless LAN module, said Wireless LAN module being adapted to provide a wireless access interface which transmits packets to and receives packets from said wireless network:
an optical fiber module, said optical fiber module being adapted to provide an optical fiber access interface which transmits packets to and receives packets from said network;
an Ethernet access module, said optical fiber module being adapted to provide an Ethernet access interface which transmits packets to and receives packets from said network;
a network expansion module with Ethernet access interface, wireless access interface, optical fiber interfaces and/or any other network interfaces, said network expansion module being adapted to provide access interfaces which transmits packets to and receives packets from said network;
a content filter module, said content fiber module is adapted to provide analysis and isolation as well as further operation of packets according to their content;
a virtual private network module, said virtual private network module being adapted to implement a virtual private network.; and
a second CPU module, said second CPU module being adapted to implement any other functions.

16. The configurable modular networking system of claim 9, wherein one or more co-processor may be coupled to said CPU to assist said CPU managing said networking system.

17. The configurable modular networking system of claim 9, wherein said network function modules embedded in said communication IC comprises at least one of the following:
Firewall, Application Firewall, VPN, DoS/DDoS prevention, IDS/IPS, Content Security, Policy-based AAA (Authorization, Authentication, Accounting), Anti-Virus, Anti-Spam, URI blocking, WLAN Security, NAT/NAPT, Policies, policy-based subscriber authorization and authentication, bandwidth management, multi-ISP supporting, switching and routing, flow control, flow monitoring, load balancing, QoS, customization of billing policy based on service, wire-speed layer two to layer four switching/policy routing, rate control, multi-policy of QoS, flow classification, flow control/management, session rate control/management, multicast routing, policy routing and redirection, and remote monitoring.

18. A method of configuring the networking system of claim 9, comprising the following steps:
coupling the modules to the system as necessary;
searching all the keys including said secret keys, said hardware keys, said general module keys and said software keys;
configuring said software modules, networking function modules, general network modules and hardware modules according to said software keys, hardware keys, general module keys and secret keys.; and
enabling said software modules, networking function modules, general network modules and hardware modules according to said software keys, hardware keys, general module keys and secret keys.

19. A method of configuring the networking system of claim 18, comprising the priority and operations among said software keys, hardware keys, general module keys and secret keys.

20. The configurable modular networking system of claim 9 comprising that the physically plugged-in module of said system could be, on a single physical board, the single or composition of said first memory device, said hardware module, said general network module and said second memory device.

21. A networking platform, comprising:
a system core managing the operation of said platform;
a network chipset providing a plurality of networking functions;
a first backplane coupling to said system core, said first backplane being adapted to deliver information from said system core to said network chipset and vice versa; and
at least one key which said system core enables or disables said networking functions according to all keys coupling to said platform.

22. The networking platform according to claim 21, wherein said first backplane further providing a plurality of interfaces such that a plurality of standard modules is able to be coupled to said platform.

23. The networking platform according to claim 21, further comprises a second backplane coupling to said network chipset, said second backplane provides a plurality of interfaces such that a plurality of traffic interface modules are able to be coupled to said platform and provide different types of network traffic interfaces.

24. The networking platform according to claim 23, wherein each of said traffic interface modules comprises at least one key such that said system core enables or disables said networking functions according to all keys coupling to said platform.

25. The networking platform according to claim 21 further comprising a third backplane coupling to said network chipset and/or said first backplane such that a plurality function modules may be coupled to said system platform, said function modules compensate the insufficiency of the capability of said network chipset.

26. The networking platform according to claim 25, wherein each of said function modules comprises at least one key such that said system core enables or disables said networking functions according to all keys coupling to said platform.

27. A method of configuring a modular networking system with at least one key which stores configuration information comprising:
searching keys stored in a networking platform for said configuration information;
searching keys stored in all modules for configuration information; and
configuring said modular networking system according to found configuration data.

28. The method of claim 27, said networking platform comprises:
a first backplane providing interfaces for at least one hardware key module being able to couple to said system;
a second backplane providing interfaces for at least one traffic interface module being able to couple to said system; and
a third backplane providing interfaces for at least one function module being able to couple to said system; wherein:
said hardware key module, said traffic interface module and said function module are capable of storing at least one said key.
